(19) United States
(12) Patent Application Publication
(10) Pub. No.: US 2008/0303227 A1
(43) Pub. Date: Dec. 11, 2008

(54) MODEL VEHICLE CHASSIS

(76) Inventor: Pak Chi Chun Idiot, Chai Wan (HK)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/761,189

(22) Filed: Jun. 11, 2007

(51) Int. Cl. B60R 27/00

(52) U.S. Cl. 280/1

(57) ABSTRACT

A model vehicle chassis has a main body and a front right suspension connected with the main body. The front right suspension has a lower suspension arm which includes a frontward piece and a mating rearward piece. Both the frontward and rearward pieces include frontward and rearward left connecting arms which extend toward and are connected with the main body. The frontward left connecting arm has a first cup and the rearward left connecting arm has a second cup. A shaft is connected with a front right lower portion of the main body. A pin runs through the shaft so that the forward and rearward ends of the pin extend through opposing ends of the shaft and engages the first and second cups, respectively.

### BACKGROUND

The present invention relates to a model vehicle, and in particular, a chassis for a model vehicle with an improved parts structure to simplify and ease assembly.

Model vehicle chassis assembled at 1/18th or larger scale have desirable features which are not found in smaller scale model vehicle chassis, such as front and rear independent four wheel suspensions and front steering. These features require additional parts which become increasingly difficult to assemble at a scale smaller than 1/18th. Independent four wheel suspensions typically include components such as upper and lower suspension arms which are fastened to a vehicle body at one end and to a C-hub and steering knuckle at a second end. In certain vehicle chassis, the lower suspension arm is a one-piece structure which is fastened to the vehicle body at one end using a hinge pin and an e-clip, and to the C-hub at a second end using a second hinge pin and e-clip. Additionally, the upper suspension arm may be fastened to the C-hub at one end using a third hinge pin and e-clip. Assembling vehicle parts, such as the upper and lower suspension arms, to other parts within the vehicle chassis using a hinge pins and e-clips is time consuming and difficult at very small scales. It would be desirable to assemble parts within a vehicle chassis without the use of hinge pins and e-clips.

In some vehicle chassis, a wheel is mounted to the vehicle chassis using a wheel lock nut which is fastened to a threaded wheel shaft. At small scales it is difficult to attach a nut to a threaded shaft and it would be desirable to be able to assemble the wheel to the vehicle chassis without having to use a wheel lock nut or a threaded wheel shaft.

In certain vehicle chassis a steering knuckle is movably connected with a C-hub through a pair of king pins which are inserted through top and bottom openings in the C-hub and attached to top and bottom fastening points on the steering knuckle. Again, at small scales it is difficult to perform such an attachment and it would be desirable to be able to movably connect the steering knuckle to the C-hub without using king pins.

### SUMMARY

According to one aspect of the present invention, a lower suspension arm of a model vehicle chassis is provided. The lower suspension arm includes a frontward piece and a rearward piece which mates with the frontward piece. Both the frontward and rearward pieces include frontward and rearward connecting arms which extend toward and are connected with a main body of the model vehicle chassis. The frontward connecting arm has a first cup and the rearward connecting arm has a second cup. The lower suspension arm also includes a shaft formed through a front right lower portion of the main body and a pin. The pin has forward and rearward ends which extend through opposing ends of the shaft and which are engaged and surrounded by the first and second cups, respectively.

According to another aspect of the present invention, a model vehicle chassis is provided. The chassis includes a universal drive shaft connected to a main body of the chassis at a first end and a first engagement member at a second end. The chassis also includes a wheel having a rim surrounded by a tire. The wheel forms a second engagement member on an inner surface of the rim which mates with the first engagement member.

According to another aspect of the present invention, a front suspension of a model vehicle chassis is provided. The front suspension includes a C-hub and upper and lower suspension arms. The upper and lower suspension arms are connected with a main body at first ends and with the C-hub at second ends. The front suspension also includes a steering knuckle forming upper and lower protrusions. The upper and lower protrusions are movably connected with the C-hub.

According to another aspect of the present invention, a front suspension of a model vehicle chassis is provided. The front suspension includes a C-hub and upper and lower suspension arms. The upper and lower suspension arms are connected to a main body of the model vehicle chassis at first ends and to the C-hub at second ends. The upper suspension arm is connected to the C-hub using a single-piece fastener.

According to another aspect of the present invention, a front suspension of a model vehicle chassis is provided. The front suspension includes a spring coil shock and a lower suspension arm. The lower suspension arm is connected at one end to a main body of the model vehicle chassis and the spring coil shock. The lower suspension arm includes a frontward piece and a rearward piece which is mated with the frontward piece. The frontward piece includes a ball-shaped protrusion. The spring coil shock is movably connected with the ball-shaped protrusion at a lower end of the spring coil shock.

### BRIEF DESCRIPTION OF THE DRAWINGS

FIG. 1 is a front perspective view of a model vehicle, in accordance with one embodiment;

FIG. 2 is a top view of the of the model vehicle of FIG. 1, in accordance with one embodiment;

FIGS. 3 is a right side view of the of the model vehicle of FIG. 1, in accordance with one embodiment

FIG. 4 is a front view of the of the model vehicle of FIG. 1, in accordance with one embodiment;

FIG. 5 is a rear view of the of the model vehicle of FIG. 1, in accordance with one embodiment;

FIG. 6 is a bottom view of the of the model vehicle of FIG. 1, in accordance with one embodiment;

FIG. 7 is a front perspective view of a chassis of the model vehicle of FIG. 1, in accordance with one embodiment;

FIG. 8 is a top view of the chassis of FIG. 7, in accordance with one embodiment;

FIG. 9 is a right side view of the chassis of FIG. 7, in accordance with one embodiment;

FIG. 10 is a front view of the chassis of FIG. 7, in accordance with one embodiment;

FIG. 11 is a rear view of the chassis of FIG. 7, in accordance with one embodiment;

FIG. 12 is a bottom view of the chassis of FIG. 7, in accordance with one embodiment;

FIG. 13 is a partially exploded front perspective view of a chassis for a model vehicle, in accordance with one embodiment;

FIGS. 14-18 are partially exploded front perspective views of a front right suspension for a chassis of a model vehicle in various forms of assembly, in accordance with one embodiment;

FIG. 19 is a side view of lower and upper holders pieces of a chassis of a model vehicle, in accordance with one embodiment;

FIGS. 20-22 are partially exploded front perspective views of a front right suspension for a chassis of a model vehicle in various forms of assembly, in accordance with one embodiment; and

FIG. 23 is a front view of a front right spring coil shock of a front right suspension for a chassis of a model vehicle, in accordance with one embodiment.

It should be appreciated that for simplicity and clarity of illustration, elements shown in the Figures have not necessarily been drawn to scale. For example, the dimensions of some elements may be exaggerated relative to each other for clarity. Further, where considered appropriate, reference numerals have been repeated among the Figures to indicate corresponding elements.

### DETAILED DESCRIPTION

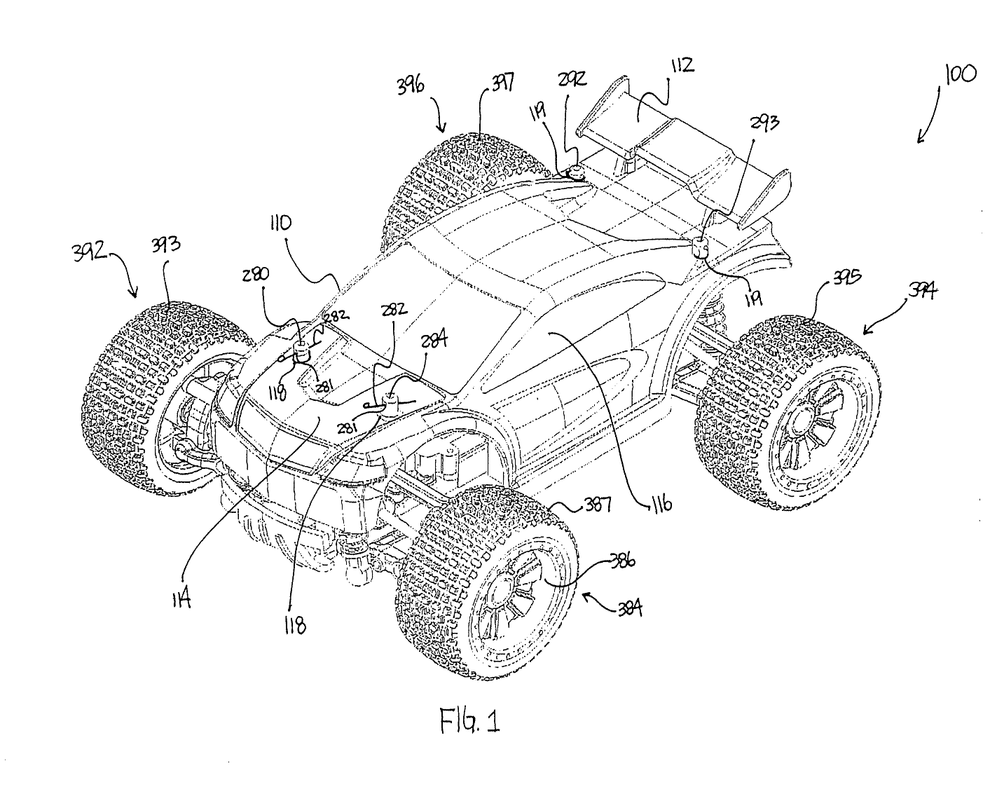

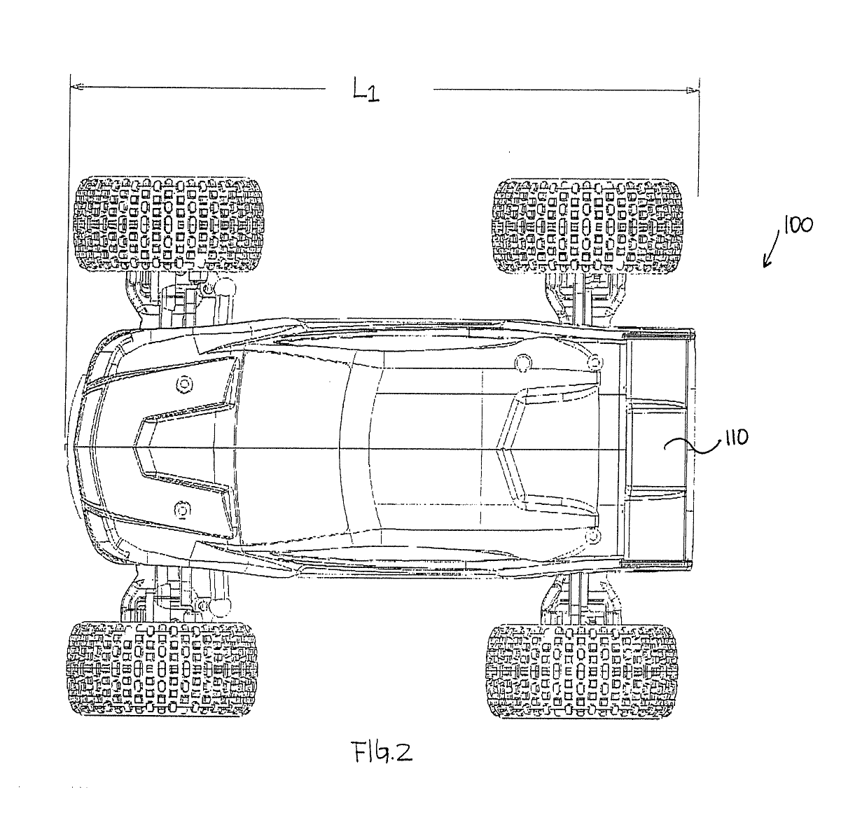

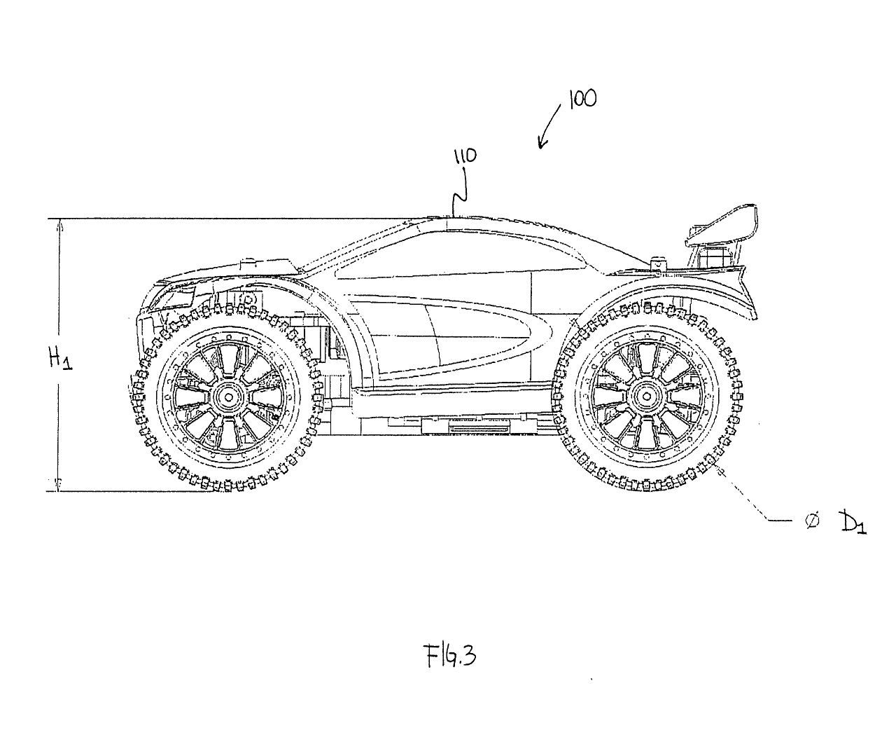

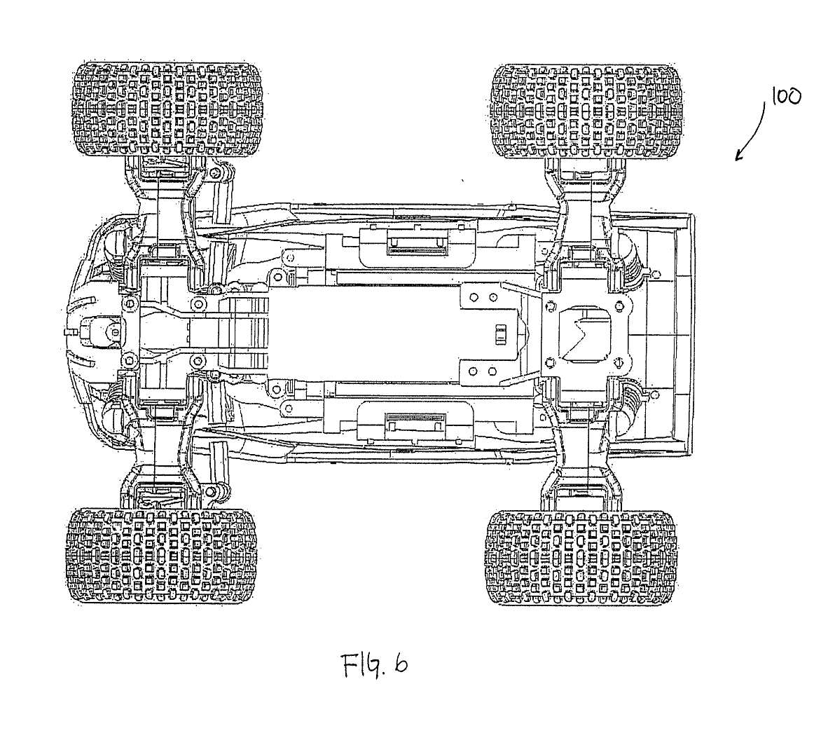

Shown in FIGS. 1-6 are various views of a model vehicle 100 including a vehicle body 110 mounted onto a vehicle chassis 130. Model vehicle 100 is preferably a radio controlled vehicle which includes an electric motor, an antenna not shown, and a servo for receiving commands from a control module and relaying said commands to the front wheels. The model vehicle 100 is preferably a small scale model of an actual vehicle. Preferably, the model vehicle is at 1/18 scale or smaller, and more preferably at 1/24^{th} scale or smaller.

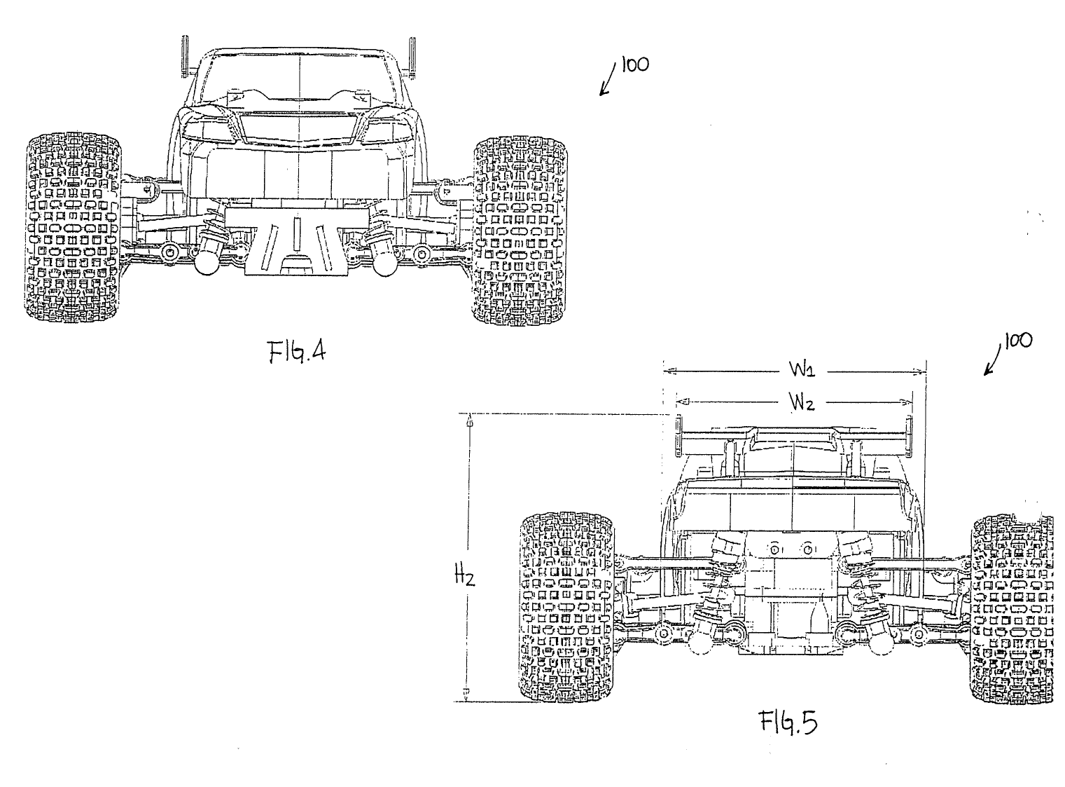

As shown in FIG. 2, the model vehicle 100 has a general length L₁, measured from front to back of the body 110, of between 12 and 20 cm, preferably between 12 and 17 cm, and more preferably about 15 cm. As shown in FIG. 3 the model vehicle has a height H₁, measured from the bottom of the front wheel 384 to the top of the vehicle body 110, of between 5 and 10 cm, and preferably between 6 and 9 cm. Additionally, the wheels have a diameter D₁ of between 1 and 7 cm, and preferably between 4 and 5 cm. As shown in FIG. 5 the model vehicle 100 has a height H₂, measures from the bottom of the wheel 384 to the top of the rear spoiler 112 of the vehicle body 110, of between 5 and 10 cm, and preferably between 6 and 9 cm. Preferably, the height H₂ is greater than the height H₁. Additionally, the model vehicle body 100 has a width W₁ of the vehicle body 110 which is between 5 and 8 cm and a width W₂ which is between 4 and 6 cm.

The vehicle body 110 can take any one of numerous shapes of various different vehicles, including a car as shown in FIG. 1, a truck, a sport utility vehicle, or other such vehicles. In the example shown in FIG. 1, the vehicle body 110 includes a rear spoiler 112, a hood 114, windows 116 and front and rear openings 118,119. Preferably, the vehicle body 110 is manufactured from a light-weight, rigid plastic through press molding.

The vehicle body 110 forms front and rear openings 118,119 through the vehicle body 110 for allowing connecting rods 280, 284, 292, 293, which are connected with the vehicle chassis 130, to protrude through the vehicle body 110 and connect the vehicle body 110 to the vehicle chassis 130. Each connecting rod 280, 284, 292, 293 has at least one hole 281 through which a fastener 282 may be placed through in order to secure the vehicle body 110 to the vehicle chassis 130, as shown in FIG. 1.

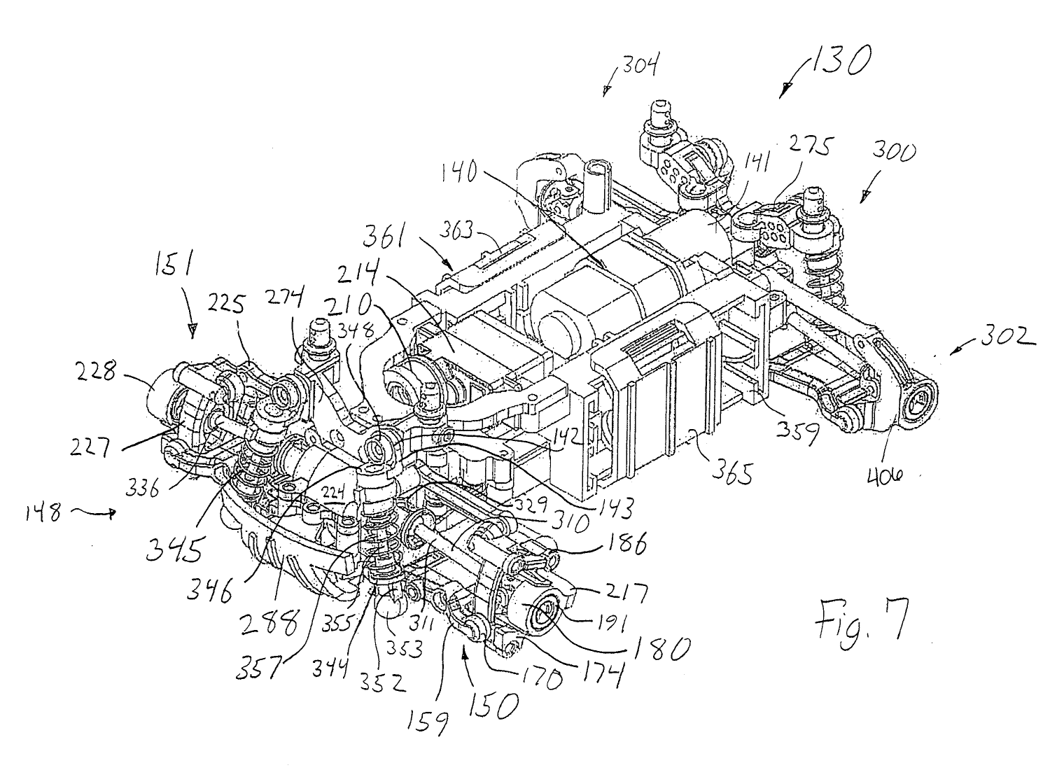

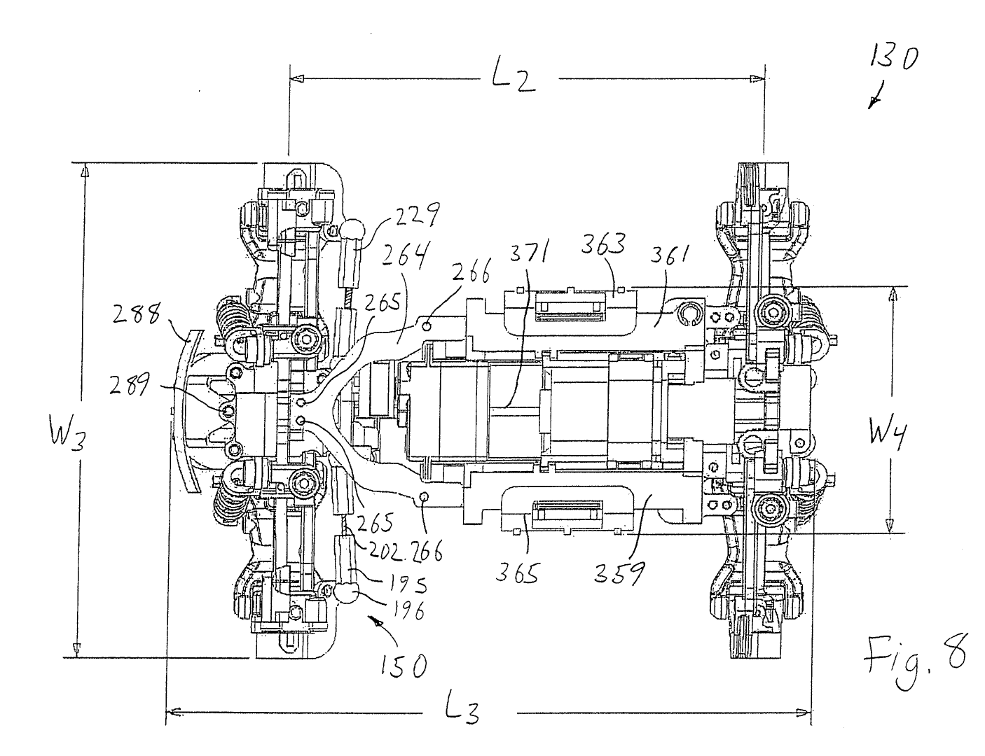

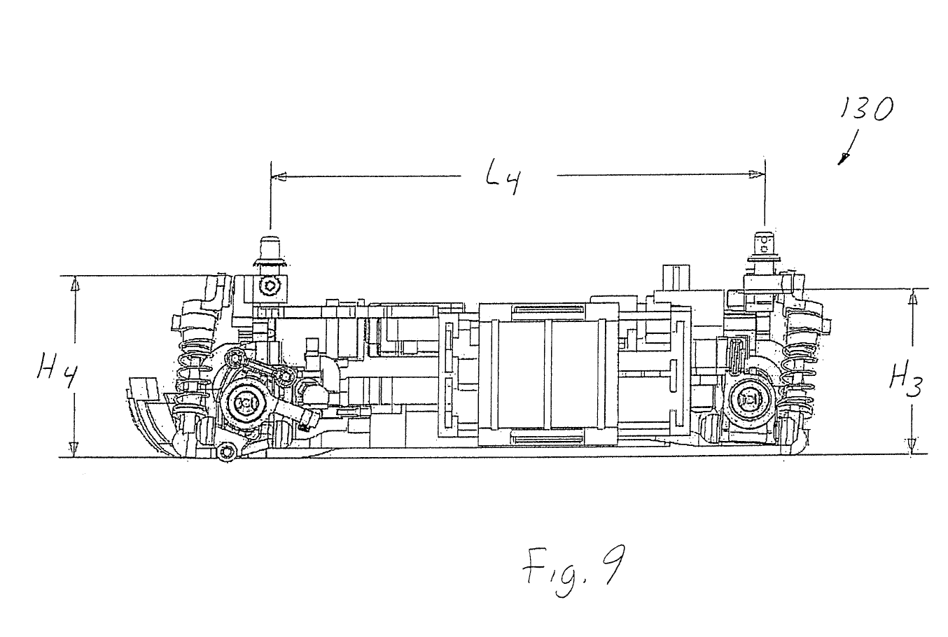

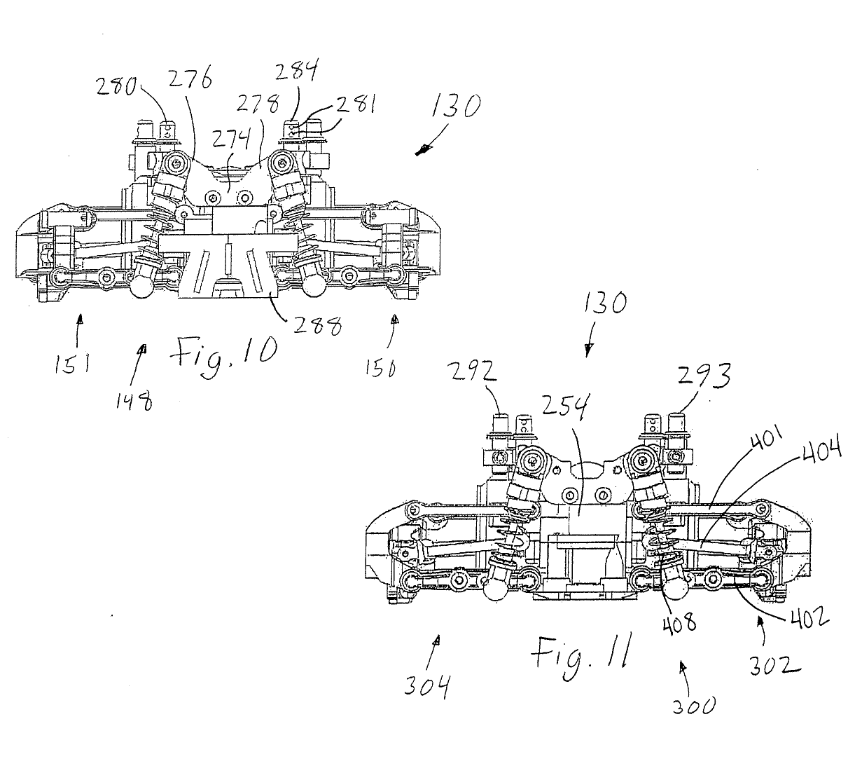

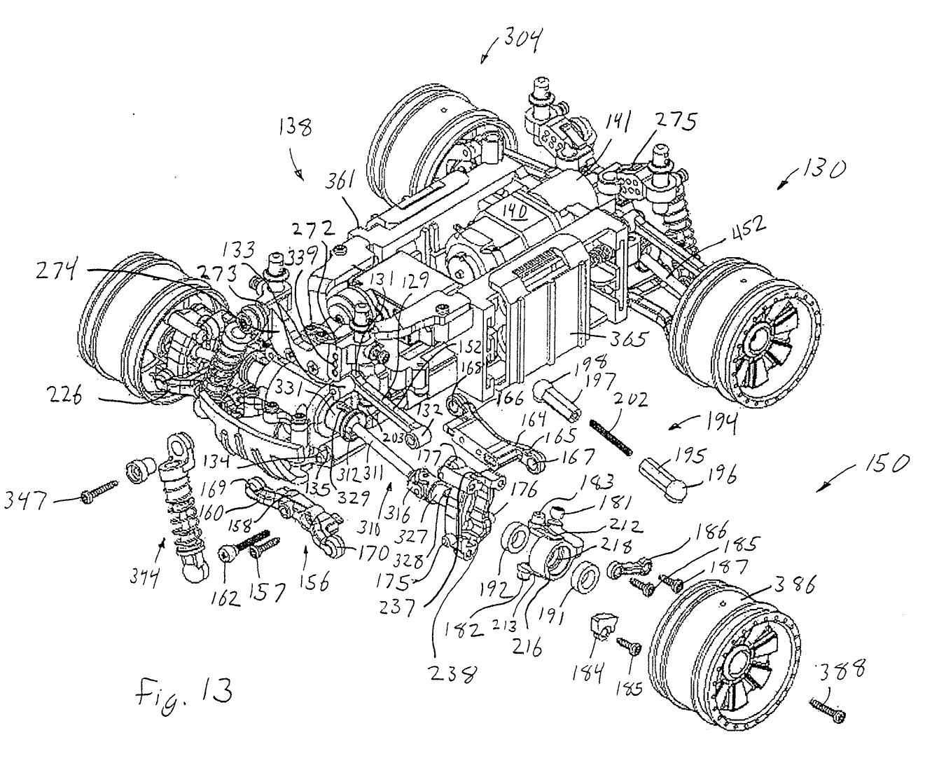

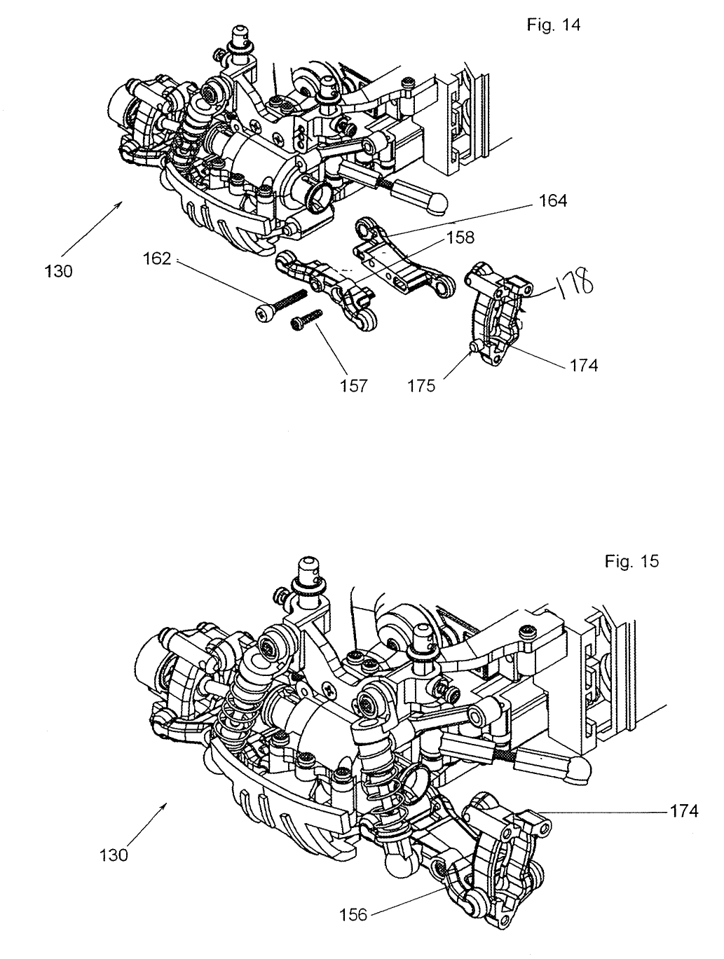

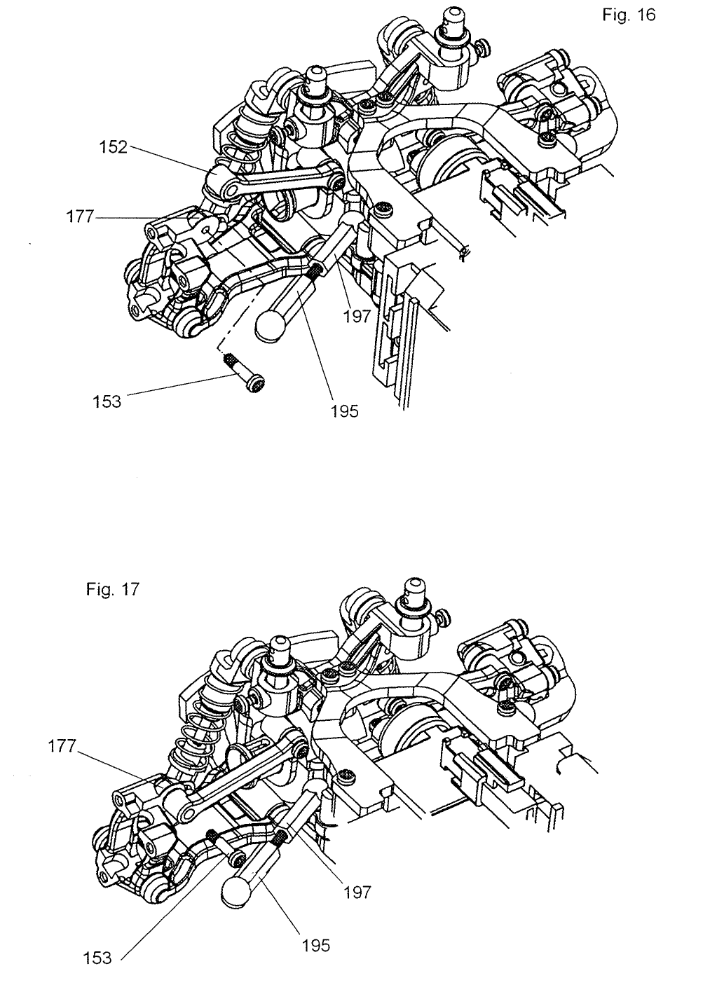

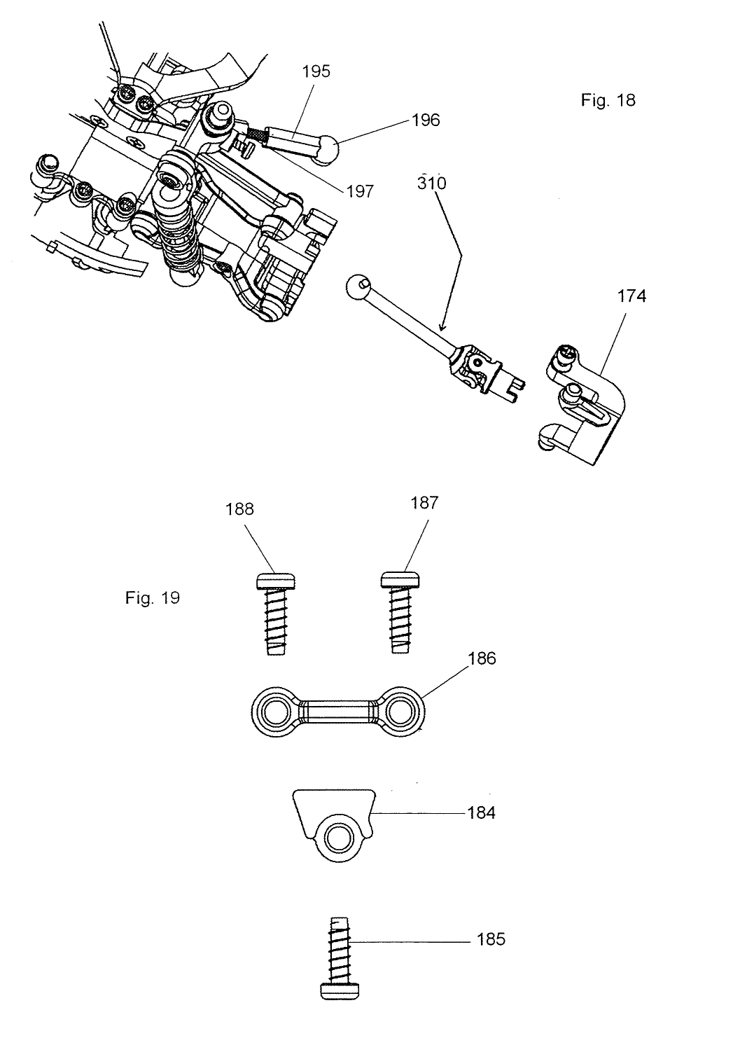

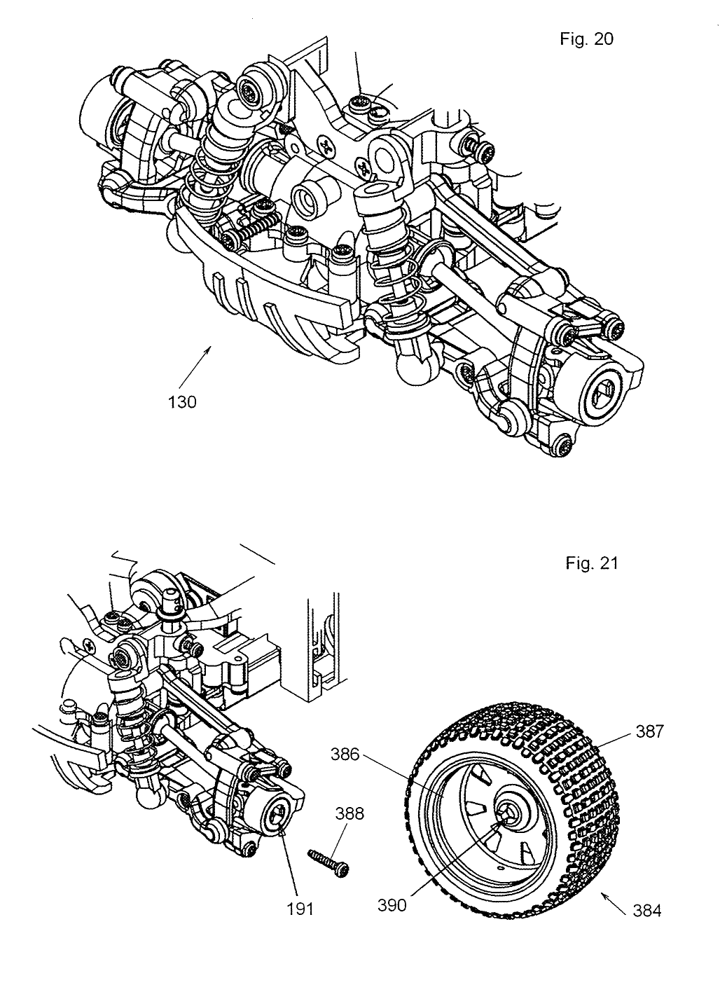

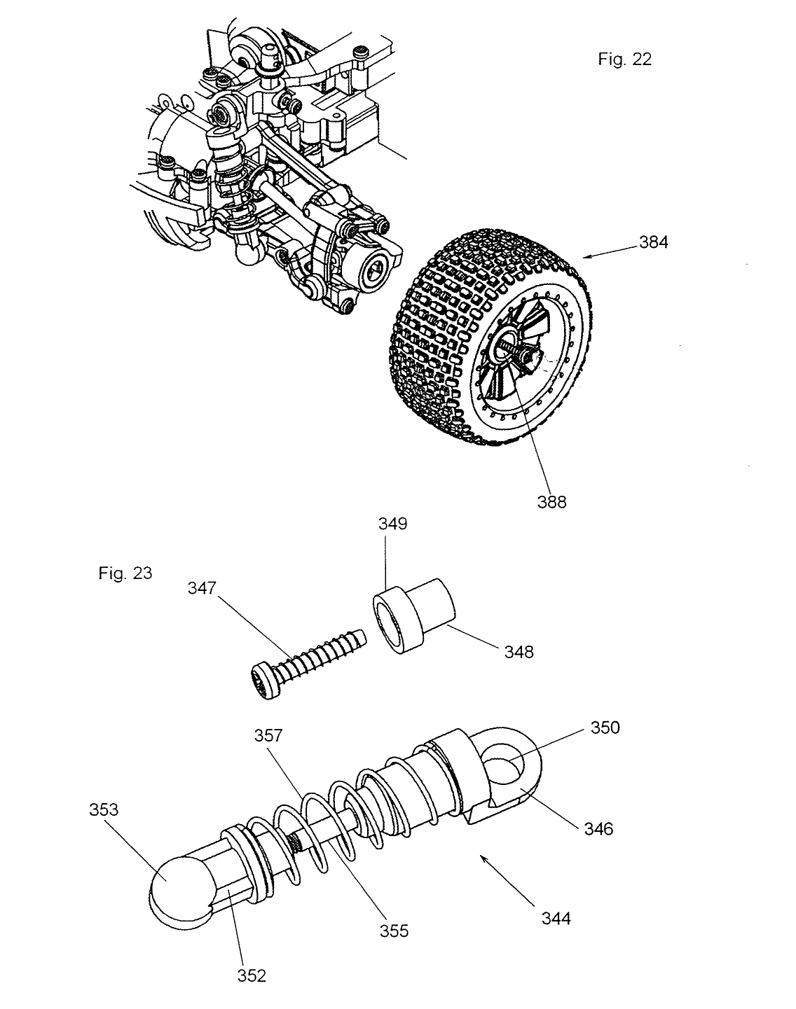

Shown in FIGS. 7-13, the chassis 130 for the model vehicle 100 includes independent front and rear suspensions 148, 300 (FIG. 13) which are connected with a main body 138. The main body 138, as shown in FIG. 13 and as described in more detail below, includes a main plate 234 which is connected with a rear plate 244, a front differential 224 mounted on the main plate 234 and a rear differential 254 which is mounted on the rear plate 244. The main body 138 also includes a motor 140 mechanically connected with both the front and rear differentials 224, 254 through a four wheel drive shaft 371 and a left battery cage 361 connected to a right battery cage 359 mounted on left and right sides, respectively, of the main and rear plates 234, 244. The main body further includes: front and rear U-mounts 274, 275 which are mounted on the front and rear differentials 224, 254, respectively; a U-shaped frame 264 connected with the front U-mount 274 at a first end and with the servo 214 and the left and right battery cages 361, 359 at a second end; and a servo 214 mounted above the main plate 234 and connected with the U-shaped frame 264.

The independent front suspension 148 includes a front left suspension 150 and a front right suspension 151 (FIG. 7) which both include similar but symmetric components. The front suspension 148, which includes the front left and right suspensions 150, 151 is involved, in conjunction with the servo 214, with steering the model vehicle 100 through the movement of the front wheels 384, 392. Additionally, the front suspension 148 helps to dampen the vertical movements of the front wheels 384, 392 to provide better gripping and traction for the model vehicle 100. The front right suspension 151 includes an upper suspension arm 225, a lower suspension arm 226, a C-hub 227, a steering knuckle 228, a steering bar 194, a universal drive shaft 336, a spring coil shock 345, and a wheel 392, as shown in FIGS. 1, 7, and 13. The front right suspension 151 mirrors the front left suspension 150 and contains components which mirror components on the front left suspension 150. For brevity of illustration, only the front left suspension 150 will be described in detail.

The front left suspension 150 includes an upper suspension arm 152, a lower suspension arm 156, a C-hub 174, a steering knuckle 180, a steering bar 194, a universal drive shaft 310, a front right spring coil shock 344, and a wheel 384. The upper suspension arm 152 includes an elongate member 129 with left and right connecting portions 131, 132 formed at opposing ends of the elongate member 129. Preferably, the upper suspension arm 152 is molded and formed from a semi-rigid to rigid material such as plastic, wood, or metal. The left connecting portion 131 is movably connected with the main body 138, preferably to a connecting portion 133 attached to the front differential 224, as shown in FIG. 13. The right connecting portion 132 is movably connected with a receiving portion 177 of the C-hub 174. Preferably, the left and right connecting portions 131, 132 each form a respective opening through which fasteners are extended to connect the left and right connecting portions 131, 132, respectively, to the connecting portion 133 and the receiving portion 177. As used herein, movable fasteners, such as fastener 153, may be any type of fasteners which fasten one element to another yet allows the one element to be at least partially rotated with respect to the other element. The movable fasteners include such mechanical fasteners as screws, nuts and bolts, nails, pins and clips, rods, and snap-fit or press-fit arrangements. Preferably, the movable fasteners are single-piece fasteners, such as king pins, which can be screwed into the connecting portion 133 and the receiving portion 177, respectively. By using movable fasteners which are single-piece, such as king pins, instead of two-piece fasteners such as hinge pins and e-clips, the upper suspension arm 152 can be more quickly and more easily connected with the main body 138 and the C-hub 174.

The lower suspension arm 156 is a generally H-shaped structure which is divided into two pieces, a frontward piece 158 and a rearward piece 164 which is mated with the frontward piece 158. The frontward piece 158 includes a left connecting arm 160 connected to a right connecting arm 159, while the rearward piece includes a left connecting arm 166 and a right connecting arm 165, as shown in FIG. 13. At their open ends, connecting arms 159, 160, 165, 166 are connected to a single cup 170, 169, 167, 168, respectively. The lower suspension arm 156 is connected with the main body 138 through a pin 134 which extends through a front right shaft 135 which is connected with a front right lower portion of the main plate 234. Cups 168, 169 engage and surround opposing ends of the pin 134, and the frontward piece 158 is in turn connected with the rearward piece 164 through the use of fasteners 162, 157. Preferably, fastener 162 is a fastener having a ball-shaped end, as shown in FIG. 13. As used herein, fasteners, such as fasteners 162, 157, may be any type of fastener which fasten one element to another and include such mechanical fasteners as screws, nuts and bolts, nails, pins and clips, rods, and snap-fit or press-fit arrangements, hook and loop type fasteners such as VELCRO™; chemical fasteners such as epoxy or other types of glue; and welding arrangements such as arc welding, gas welding, and energy beam welding.

The lower suspension arm 156 is also connected to the C-hub 174 through a pair of protrusions 175, 176 which are integrally formed as one piece with the C-hub 174. Cups 167, 170 engage and surround an exposed end of each protrusion 175, 176 before the frontward piece 158 is connected with the rearward piece 164 through the use of fasteners 162, 157, as described above. In this manner, the upper suspension arm 152, along with the lower suspension arm 156, help to maintain the C-hub 174 along with the wheel 384 in a generally vertical orientation, while still allowing for vertical movement of the wheel 384. Additionally, by using a two-piece structure instead of a one-piece structure, and by having cups 170, 169, 167, 168, the lower suspension arm 156 is able to connect with the main body 138 and the C-hub 174 without having to use hinge pins and e-clips, simplifying assembly of the model vehicle 100.

The C-hub also forms an opening 178 through which the steering knuckle 180 is positioned. The C-hub connects to the steering knuckle 180 through a pair of upper and lower slots 237, 238 formed above and below the opening 178, respectively. The upper and lower slots 237, 238 are adapted to receive upper and lower protrusions 183, 182 integrally formed as one piece with the steering knuckle 180. The upper and lower protrusions 183, 182 are secured to the C-hub in upper and lower slots 237, 238 through upper and lower connecting members 186, 184, respectively. The upper connecting member 186 is secured to the C-hub 174 through a pair of fasteners 187, 188, while the lower connecting member 184 is secured to the C-hub through a single fastener 185. In this manner, the steering knuckle 180 is movably connected with the C-hub 174.

The steering knuckle 180 includes a central O-shaped ring 216, upper and lower arms 212, 213 which extend from top and bottom ends of the O-shaped ring 216 towards the C-Hub 174, and upper and lower protrusions 183, 182 which are mounted on the upper and lower arms 212, 213, respectively, and extend in generally opposite tangential directions from the upper and lower arms 212, 213, as shown in FIG. 13. The steering knuckle 180 further includes an L-shaped extension arm 217 which extends away from the O-shaped ring 216 and towards the steering bar 194. At a first end, the L-shaped extension arm 217 is connected with the O-shaped ring 216, and at a second end the L-shaped extension arm 217 has a fastener 181 with a ball-shaped end extending from a top surface of the L-shaped extension arm 217. Additionally, the steering knuckle 180 includes first and second bearings 191, 192 fitted within the O-shaped ring 216 and separated by a circular ridge 218 formed along an inside surface of the O-shaped ring 216.

The steering knuckle 180 is movably connected with the C-hub 174 through the upper and lower protrusions 183, 182 which are placed in upper and lower slots 237, 238. The upper and lower protrusions 183, 182 are able to rotate within the upper and lower slots 237, 238 to a certain extent. This allows for the steering bar 194 to move the front right wheel 384 from a normal position, in which the front right wheel 384 is pointed straight ahead and generally tangent to the front universal drive shaft 310, to a turning position, in which the front right wheel 384 is pointed to the right or left of the chassis 130 and generally not tangent to the front universal drive shaft 310. By having upper and lower protrusions 183, 182 which are placed in upper and lower slots 237, 238 formed in the C-hub 174, the steering knuckle 180 can be connected with the C-hub 174 without having to use king pins, simplifying assembly of the model vehicle 100.

The steering knuckle 180 is also connected to the steering bar 194 through the ball-shaped end of the fastener 181. The steering bar 194 includes a first member 195 connected with a second member 197 through a threaded fastener 202 attached to adjacent ends of the first and second members 195, 197. The threaded fastener 202 allows for the distance between the first and second members 195, 197 to be adjusted. Additionally, cups 196, 198 are formed at opposing ends of the first and second members 195, 197, respectively. Cup 196 engages the ball-shaped end of the fastener 181. Preferably, the cup 196 is in a snap-fit arrangement with the ball-shaped end of the fastener 181, allowing the cup 196 to move in relation to the ball-shaped end of the fastener 181, but preventing the cup 196 from disengaging the ball-shaped end of the fastener 181. Cup 198 engages a ball-shaped end of a fastener (not shown) which is connected with the chassis 130, generally, and more specifically connected with a linkage 203 which is connected with the chassis 130, as described below. Preferably, the cup 198 is in a snap-fit arrangement with the ball-shaped end of the fastener, allowing the cup 198 to move in relation to the ball-shaped end of the fastener, but preventing the cup 198 from disengaging the ball-shaped end of the fastener.

The universal drive shaft 310 includes a connecting ball 312 having upper and lower protrusions (not shown) a main shaft 311 connected at one end to the connecting ball 312 and at an opposing end to a universal joint 316. The upper and lower protrusions of the connecting ball 312 are situated within an upper slot 329 and a lower slot (not shown), respectively, of a cylindrical coupling 331. The cylindrical coupling 331 is movably connected with the front differential 224, as shown in FIG. 13.

The universal joint 316 is fixedly connected with a shaft 327 which extends through and is surrounded by the O-shaped ring 216, and the bearings 191, 192 within the O-shaped ring 216. The shaft 327 is connected to the universal joint 316 at a first end and forms an engagement member 328 at a second end. The engagement member 328 mates with a complimentary engagement member 390, as shown in FIG. 21, which is centrally located on the front left wheel 386. The wheel 386 is connected with the universal drive shaft 310 by using a single fastener 388, as shown in FIG. 13. Preferably, the fastener 388 is a screw which is inserted through an opening in the wheel 386 and threaded into a threaded opening in the shaft 327. By using engagement members 328, 390, a single fastener 388 can be used to attach the wheel 386 to the universal drive shaft 310.

The front right spring coil shock 344 includes a hollow upper portion 346, a lower portion 352, and a piston 355 fixedly connected to the lower portion at one end and movably connected within the hollow upper portion 346 at an opposing end. The front right spring coil shock 344 also includes a spring 357 which surrounds the upper and lower portions 346, 352. At a first end, the spring 357 is connected with the upper portion 346, and at a second end the spring 357 is connected with the lower portion 352, as shown in FIG. 13. The spring 357 dampens the motion between the upper portion 346 and the lower portion 352 through compression of the spring 357. The front right spring coil shock 344 further includes a cylindrical sleeve 348 positioned through an opening 142 formed through an L-shaped member 143 connected to a top end of the upper portion 346 and a cup 353 connected with a bottom end of the lower portion 352, which opposes the top end of the upper portion 346. The cylindrical sleeve 348 includes a frontward portion having a first diameter connected with a rearward portion having a second diameter, wherein the second diameter is smaller the diameter of the opening 142 while the first diameter is larger than the diameter of the opening 142.

At an upper end, the front right spring coil shock 344 is connected with a right portion 272 of a front U-mount 274 using a fastener 347 which goes through the cylindrical sleeve 348 and into a hole 339 formed in the right portion 272. The front U-mount 274 is mounted on the front differential 224, as shown in FIG. 13. At a lower end opposing the upper end, the front right spring coil shock 344 is movably connected with a ball-shaped protrusion of a fastener 162 through the cup 353. In one embodiment, the ball shaped protrusion is integrally formed as one piece with the forward piece 158 of the lower suspension arm 156. Cup 353 engages the ball-shaped protrusion of the fastener 162. Preferably, the cup 353 is in a snap-fit arrangement with the ball-shaped protrusion of the fastener 162, allowing the cup 353 to move in relation to the ball-shaped protrusion of the fastener 162, but preventing the cup 353 from disengaging the ball-shaped protrusion of the fastener 162. Fastener 162 is connected with the lower suspension arm 156, as described above. In this manner, the front right spring coil shock 344 dampens the up and down motion of the entire front left suspension 150 with respect to the main body 138.

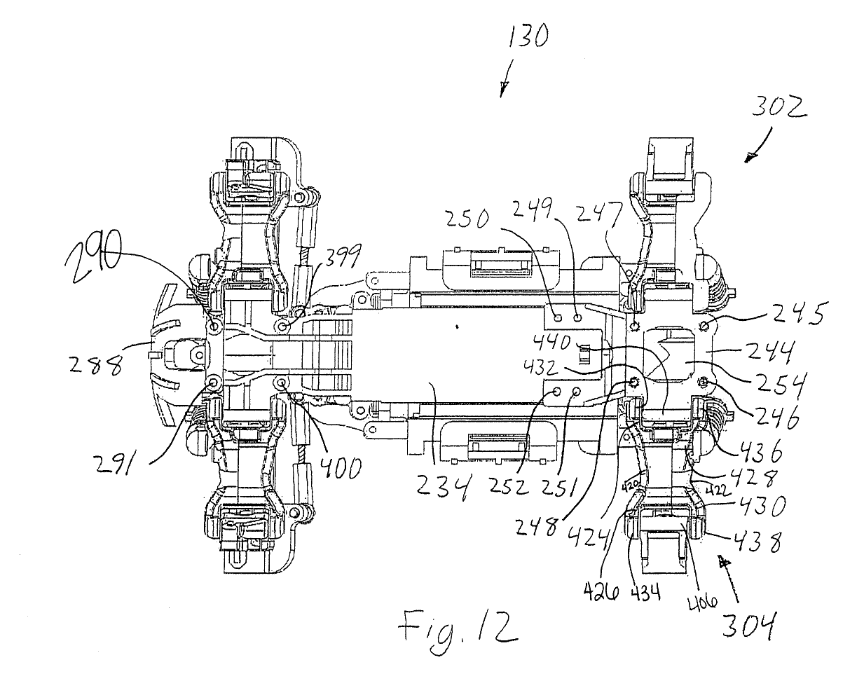

The front differential 224 is connected to a forward end of the four-wheel drive shaft 371 and transfers power from the four-wheel drive shaft 371 to both the front right and front left wheels 384, 392 through universal drive shafts 310, 336, respectively. The front differential 224 is fixedly connected with the main plate 234 using fasteners 290, 291, 399, 400. A rearward end of the four-wheel drive shaft 371 is connected to the rear differential 254. In this manner, the four-wheel drive shaft 371, in conjunction with the front and rear differentials 224, 254, enables all four wheels to turn in conjunction with each other, enabling the model vehicle 100 to evenly transfer power from the electric motor 140 to all four wheels 384, 392, 394, 396 of the model vehicle 100. The rear differential 254 is connected to the electric motor 140 through a gearbox 141 which is mounted on the rear differential 254. The gearbox 141 is used to transfer the power from the electric motor 140 to the rear differential 254. The rear differential 254 is also mounted to a rear plate 244 through a series of fasteners 245, 246, 247, 248, as shown in FIG. 12. The rear plate 244 is connected with the main plate 234 through a series of fasteners 249, 250, 251, 252.

The electric motor 140 is used to provide power to the model vehicle 100. One suitable electric motor 140 is an electric motor having a model number FC130SA-2075 and manufactured by Ranson Motor Manufacturing Co., Ltd. of Hong Kong. The electric motor 140 is electrically connected to a power source, such as batteries housed within right and left battery cages 359, 361 positioned at right and left sides of the main body 138, respectively. A snap-fit left door 363 is connected with and covers the left battery cage 361 while a snap-fit right door 365 is connected with and covers the right battery cage 359.

The servo 214 is mounted on the main plate 234 in front of the electric motor 140, as shown in FIG. 7. The servo 214 is also electrically connected to a power source, such as the batteries. The servo 214 is mechanically coupled with the steering bars 194, 229 found in the front left and front right suspensions 150,151 through linkages, such as linkage 203. The servo 214 includes a rotating member 210 (FIG. 7) which is connected with a motor (not shown) within the servo 214 at a first end and with a u-shaped connected member (not shown) at a second end. The u-shaped connected member (not shown) is then movably connected to the front left linkage 203 and a front right linkage (not shown) through a pair of pins (not shown). The front left linkage 203 is in turn movably connected with the steering bar 194, while the front right linkage (not shown) is movably connected with the steering bar 229. Upon activation, the servo 214 moves the rotating member 210 either clockwise or counterclockwise. In turn, the rotating member 210 moves the u-shaped connected member (not shown) either left or right, respectively, causing the vehicle 100 to move to the right or left, respectively.

Both the servo 214 and the electric motor 140 are connected to a control box (not shown) which receives signals from a remote handheld controller (not shown) through an antenna (not shown) mounted on the model vehicle 100. The control box (not shown) in turn sends the signals to the servo 214 or the electric motor 140. The signals instruct the servo 214 how to move the rotating member 210, and they instruct the electric motor 140 on which direction to move and how much distance to move in that direction.

In addition to a having a front U-mount 274, the chassis 130 also has a rear U-mount 275. Each portion 272, 273 of the front U-mount 274 is connected with a connecting rod 284, 280, respectively. Additionally, opposing ends of the rear U-mount 275 are connected with connecting rods 292, 293. The top U-shaped frame 264 is connected with the front U-mount 274 at a first end through a pair of fasteners 265 and with the servo 214 at opposing ends through a pair of fasteners 266. The U-shaped frame 264 provides additional structural rigidity to the chassis 130.

Shown in FIGS. 7-13 is the independent rear suspension 300 which is connected with the main body 138. The independent rear suspension 300 includes a rear right suspension 302 and a rear left suspension 304 which includes similar but symmetric components as in the rear right suspension 302.

The independent rear suspension 300 helps to dampen the vertical movements of the rear wheels 394, 396, and to provide better gripping and traction for the model vehicle 100. The rear right suspension 302 includes an upper suspension arm 401, a lower suspension arm 402, a rear hub 406, a universal drive shaft 404, a rear right spring coil shock 408, and a rear right wheel 394, as shown in FIGS. 1, 7, and 13. The rear left suspension 304 mirrors the rear right suspension 302 and contains components which mirror components on the rear right suspension 302. For brevity of illustration, only the rear right suspension 302 will be described in detail.

The upper suspension arm 401 includes an elongate member (not shown) with left and right connecting portions (not shown) formed at opposing ends of the elongate member. Preferably, the upper suspension arm 401 is molded and formed from a semi-rigid to rigid material such as, plastic, wood, or metal. The left connecting portion (not shown) is movably connected with the main body 234, preferably to a connecting member (not shown) attached to the rear differential 254. The right connecting portion (not shown) is movably connected with a receiving arm (not shown) of the rear hub (not shown). Preferably, the left and right connecting portions (not shown) each form a respective opening through which movable fasteners (not shown) connect the left and right connecting portions (not shown), respectively, to the connecting member (not shown) and the receiving arm (not shown). Preferably, the movable fasteners are king pins which can be screwed into the connecting member (not shown) and the receiving arm (not shown), respectively. By using movable fasteners, such as king pins, instead of hinge pins and e-clips, the upper suspension arm 401 can be more quickly and more easily connected with the main body 138 and the rear hub 406.

The lower suspension arm 402 is a generally H-shaped structure which is divided into two pieces, a frontward piece 420 and a rearward piece 422 which is mated with the frontward piece 420. The frontward piece 420 includes a right connecting arm 424 connected to a left connecting arm 426, while the rearward piece includes a right connecting arm 428 connected to a left connecting arm 430, as shown in FIG. 12. At open ends, the connecting arms 424, 426, 428, 430 are connected with a single cup 432, 434, 436, 438, respectively. The lower suspension arm 402 is connected with the main body 138, and more specifically, with the rear plate 244 of the main body 138, through a pin (not shown) which extends through a rear left shaft 440. Rear left shaft 440 is connected with a rear left portion of the rear plate 244. Preferably, the rear left shaft 440 is formed through a rear left portion of the rear plate 244. Cups 432, 436 engage and surround opposing ends of the pin (not shown) which extends through the rear left shaft 440. The frontward piece 420 is in turn connected with the rearward piece 422 through the use of fasteners (not shown).

The lower suspension arm 402 is also connected to the rear hub 406 through a pair of protrusions (not shown) which are integrally formed as one piece with the rear hub 406. Cups 434, 438 engage and surround an exposed end of each protrusion (not shown) formed in the rear hub 406 before the frontward piece 420 is connected with the rearward piece 422 through the use of fasteners (not shown), as described above. In this manner, the upper suspension arm 400, along with the lower suspension arm 402, help to maintain the rear hub 406 along with the wheel 394 in a generally vertical orientation, while still allowing for vertical movement of the wheel 394. Additionally, by using a two-piece structure instead of a one-piece structure, and by having cups 432, 434, 436, 438, the lower suspension arm 402 is able to connect with the main body 138 and with the rear hub 406 without having to use hinge pins and e-clips, simplifying assembly of the model vehicle 100.

The rear hub 406 also forms an opening (not shown) through which the universal drive shaft 404 is positioned. The universal drive shaft 404 is configured in much the same way as the universal drive shaft 310 and includes: a connecting ball (not shown) having upper and lower protrusions (not shown); a main shaft 452 connected at one end to the connecting ball (not shown) and at an opposing end to a first linkage; a second linkage; and an internal ball movably connecting the first linkage to the second linkage. The second linkage is fixedly connected with a shaft (not shown) which is surrounded by the opening (not shown). A bearing (not shown) is within the opening. The shaft (not shown) is connected to the second linkage at a first end and forms a first engagement member (not shown) at a second end. The first engagement member (not shown) mates with a complimentary second engagement member (not shown) which is centrally located on the rear right wheel 394. The upper and lower protrusions of the connecting ball are situated within an upper slot (not shown) and a lower slot (not shown), respectively, of a rear cylindrical coupling. The rear cylindrical coupling is movably connected with the rear differential 254.

The rear right spring coil shock 408 is formed identically to the front right spring coil shock 344 and contains identical components. The rear right spring coil shock is connected at an upper end with a right portion 278 of the rear U-mount 275 and at a lower end opposing the upper end, the spring coil shock 408 is movably connected with a ball-shaped protrusion of a fastener (not shown) through a cup formed at the lower end of the spring coil shock 408. In one embodiment, the ball shaped protrusion is integrally formed as one piece with the rearward piece 422 of the lower suspension arm 402.

As will be appreciated by those of skill in this art, the preceding examples are provided, not to limit or define the scope of the present invention, but to illustrate the nature of the present invention and possible uses for the teachings of the present invention. These examples may be modified in many different ways while still obtaining the benefits of the teachings of the present invention. While the invention has been described and illustrated, this description is by way of example only. Additional advantages will occur readily to those skilled in the art, who may make numerous changes without departing from the true spirit and scope of the invention. Therefore, the invention is not limited to the specific details, representative machines, and illustrated examples in this description. Accordingly, the scope of this invention is to be limited only as necessitated by the accompanying claims. Various features and advantages of the invention are set forth in the following claims.

What is claimed is:

1. A lower suspension arm of a model vehicle chassis comprising:
a frontward piece;
a rearward piece which mates with the frontward piece, wherein both the frontward and rearward pieces include frontward and rearward connecting arms which extend toward and are connected with a main body of the model vehicle chassis, and wherein the frontward connecting arm has a first cup and the rearward connecting arm has a second cup;
a shaft formed through a front right lower portion of the main body; and
a pin having forward and rearward ends which extend through opposing ends of the shaft and which are engaged by the first and second cups, respectively.

2. The model vehicle chassis of claim 1, wherein the front right suspension further comprises a C-hub connected with the lower suspension arm.

3. The model vehicle chassis of claim 2, wherein the C-hub forms a first protrusion extending in a forward direction, and a second protrusion opposed to the first protrusion and extending in a rearward direction, wherein the first and second protrusions are movably connected with the lower suspension arm.

4. The model vehicle chassis of claim 3, wherein both the frontward and rearward pieces of the lower suspension arm include frontward and rearward right connecting arms which extend toward and are connected with the first and second protrusions, respectively.

5. The model vehicle chassis of claim 4, wherein the frontward right connecting arm has a third cup and the rearward right connecting arm has a fourth cup, and wherein the first and second protrusions of the C-hub engage the third and fourth cups, respectively.

6. The model vehicle chassis of claim 3, wherein the first and second protrusions are integrally formed as one piece with the C-hub.

7. A model vehicle chassis comprising:
a universal drive shaft connected to a main body of the model vehicle chassis at a first end and a first engagement member at a second end; and
a wheel having a rim surrounded by a tire, the wheel forming a second engagement member on an inner surface of the rim which mates with the first engagement member.

8. The model vehicle chassis of claim 7, wherein the wheel is secured to the universal drive shaft using no more than one fastener.

9. The model vehicle chassis of claim 8, wherein the fastener is a screw.

10. A front suspension of a model vehicle chassis comprising:
a C-hub;
upper and lower suspension arms connected with a main body of the model vehicle chassis at first ends and with the C-hub at second ends; and
a steering knuckle forming upper and lower protrusions, wherein the upper and lower protrusions are movably connected with the C-hub.

11. The model vehicle chassis of claim 10, and a universal drive shaft which passes through an opening in the C-hub, the C-hub having upper and lower slots above and below the opening, and wherein the upper and lower slots are adapted to receive the upper and lower protrusions.

12. The model vehicle chassis of claim 10, wherein the upper and lower protrusions are integrally formed as one piece with the steering knuckle.

13. The model vehicle chassis of claim 10, wherein the upper and lower protrusions are secured to the C-hub in the upper and lower slots through upper and lower connecting members.

14. The model vehicle chassis of claim 13, wherein the upper connecting member is secured to the through a pair of fasteners, while the lower connecting member is secured to the C-hub through no more than one fastener.

15. A front suspension of a model vehicle chassis comprising:
a C-hub; and
upper and lower suspension arms connected to a main body of the model vehicle chassis at first ends and to the C-hub at second ends, wherein the upper suspension arm is connected to the C-hub using a single-piece fastener.

16. The model vehicle chassis of claim 15, wherein the upper suspension arm is connected to the main body using no more than one fastener.

17. The model vehicle chassis of claim 15, wherein the fastener is a king pin.

18. A front suspension of a model vehicle chassis comprising:
a spring coil shock; and
a lower suspension arm connected at one end to a main body of the model vehicle chassis and the spring coil shock, wherein the lower suspension arm includes a frontward piece and a rearward piece which is mated with the frontward piece, wherein the frontward piece includes a ball-shaped protrusion, and wherein the spring coil shock is movably connected with the ball-shaped protrusion at a lower end of the spring coil shock.

19. The model vehicle chassis of claim 18, wherein the spring coil shock is connected with the main body at an upper end of the spring coil shock using a fastener which goes through a cylindrical sleeve connected with the spring coil shock.

20. The model vehicle chassis of claim 19, wherein the spring coil shock includes an L-shaped member connected with an upper portion of the spring coil shock, wherein the L-shaped member forms an opening, and wherein the cylindrical sleeve is positioned through the opening

21. The model vehicle chassis of claim 20, wherein the cylindrical sleeve includes a frontward portion having a first diameter connected with a rearward portion having a second diameter, wherein the second diameter is smaller than a diameter of the opening while the first diameter is larger than a diameter of the opening.

22. The model vehicle chassis of claim 18, wherein the spring coil shock has a cup at the lower end of the spring coil shock, and wherein the cup engages the ball-shaped protrusion.

23. The model vehicle chassis of claim 22, wherein the cup is snap-fit with the ball-shaped protrusion.

24. The model vehicle chassis of claim 18, wherein the ball shaped protrusion is integrally formed as one piece with the forward piece of the lower suspension arm.
